(19) United States
(12) Patent Application Publication
(10) Pub. No.: US 2015/0114729 A1
(43) Pub. Date: Apr. 30, 2015

(54) Balance Arm. A device and method for creation of a variable applied force using a constant load value. The SARDA system. Development of an existing patent application

(71) Applicants: Anvar Alimov, Chicago, IL (US); Rano Alimova, Los Angeles, CA (US); Davron Alimov, Findlay, OH (US); Sevara Alimova, Los Angeles, CA (US)

(72) Inventors: Anvar Alimov, Chicago, IL (US); Rano Alimova, Los Angeles, CA (US); Davron Alimov, Findlay, OH (US); Sevara Alimova, Los Angeles, CA (US)

(21) Appl. No.: 14/068,433

(22) Filed: Oct. 31, 2013

(51) Int. Cl. G01G 21/14; G01G 21/26

(52) U.S. Cl. CPC G01G 21/14; G01G 21/26
USPC 177/235

(57) ABSTRACT

A Balance Arm with treads or notches on one of its halves with a moveable constant load, for example one or two weights, as the device creates a new method of creating a variable force using a constant load. The scope of application of this device and its method are limitless—it can be applied in all cases where creation of a variable applied force which must change depending on need of the user, with the aid of a constant load, is required. The simplicity of the device and of the method makes it possible to do this smoothly, quickly, reliably, safely, and inexpensively.

### CROSS-REFERENCE TO RELATED APPLICATIONS

This patent application is a Continuation-In-Part and development of certain sections of the previous patent application Ser. No. 13/799,845 filed on May 8, 2013.

### FEDERALLY SPONSORED RESEARCH

Not Applicable

### SEQUENCE LISTING OR PROGRAM

Not Applicable

### BACKGROUND OF THE INVENTION

### 1. Field of the Invention

This invention pertains to a device for creation of a variable applied force by means of a constant load, with the Device used as a means to transfer a smoothly variable applied force on the an object of the effect of the applied force. Above all, the use of the principle of operation of the Balance Arm differs from previous inventions. The device is extremely simple, and one or two balance weights are the main applied force components. There is no need for replaceable weights of different weight and quantity. Due to simple and smoothly movement of one or two weights on one shoulder of the Device a smooth selection of the needed variable applied force on the other is achieved.

### SUMMARY OF THE INVENTION

The inventions described above and applied for are a Device for creating an Applied force by means of a Load (at least one or two weights). The device is a Device, on which one half of which (B) a Load (for example, at least 1 weight) moves. A Load in the form of one or two weights moving along one of the halves of the Device creates an Applied force on the other half of the Device (A), to which the Object is attached. In this, the Device allows changing smoothly the size of the Applied force by moving the Load and fastening it at any location on the Device with a tread, by simple tightening pairs of weights against each other. In the case of use of one weight of special design with a tooth and a clamping spring in it, this allows reliably fastening it at any location by means of notches cut on the Device half (B).

The Device may both rest on a support and be suspended by means of the same support—depending on the conditions and requirements of its use. In each case, depending on the requirements, it is possible to change the height of fluctuation of shoulder (A). This is achieved either by changing the length of the shoulders by moving the support to one side or another, or by lengthening one or both halves of the Device. When needed, the height of the support also changes. This provides a greater or lesser length of one of the shoulders of the Device and correspondingly the vertical amplitude of the fluctuation of shoulder (A). The method includes the possibility of selecting Devices with various limits of the specified Applied force reached, initially, by selection of the weight of a Load or by a change in the length of shoulder (B). Thus if necessary the Device will show a small applied force, with short shoulders (A) and/or (B) and a small Load, and vice versa.

By means of changing the design of shoulder (A), it is possible to change the direction of the force created. So when shoulder (A) is turned upwards 90 degrees from the horizontal position, the Device will create a pulling force, and when turned downwards 90 degrees from horizontal it creates a pushing force. In the horizontal position there is an elevating force.

There are no restrictions on the use of the Device, and it may be applied in all types of machines, mechanisms, instruments, sports apparatus, medical instruments and devices, and other various devices, machines, and mechanisms where creation of a smoothly variable applied force by means of a constant load is required.

The objectives of this invention are the following:

a new and useful device and method for creating an Applied force by means of a Load with use of this unique Device for creating an applied force, based on use of the Balance Arm's principle of operation with a variable load onto one shoulder (A) from a constant load, for example one or two weights, due to their motion along shoulder (B) of the Device;

a new and useful device and method with use of the Device that allows creating an elevating force in the horizontal position of shoulder (A), a pulling force when shoulder (A) is turned up, and a pushing force when shoulder (A) is turned down;

a new and useful device and method for creating an Applied force by means of a Load (at least one weight) by the use of the Device as a means of transferring a smoothly variable load onto the Object;

a new and useful device and method for creating an Applied force that includes the possibility of selection of Devices with various limits of the specified Applied force reached, initially, by selection of the weight of a Load or by a change in the length of shoulder (A) and/or (B). Thus if necessary the Device will show a small Applied force, with short shoulders (A) and/or (B) and a small Load, and vice versa;

a new and useful device and method for creating an Applied force that includes an alternative where only one end of the Device rests on a support, and a connecting rod leading to the Object that fastens to shoulder (A) by means of a slider, and which connecting rod may move along shoulder (A) and thereby change the amplitude of motion of the Object.

a new and useful device and method for creating an Applied force that includes an alternative where only one end of the Device rests on a support, and to the other end of the Device is fastened a connecting rod leading to the Object and the Load moves on shoulder (A) and (B);

a new and useful device and method for creating an Applied force that includes establishment of a graduated scale of the applied force on a shoulder using a Load and making it possible to define the size of the force applied to the Object;

### BRIEF DESCRIPTION OF DRAWINGS

FIG. 1. General view of alternatives of the Device of the SARDA system.

FIG. 2. Device with one and two weights and a scale of measurement of the size of the Applied force on the Object.

FIG. 3. Device resting one end of the Device on a support.

### DESCRIPTION OF DRAWINGS

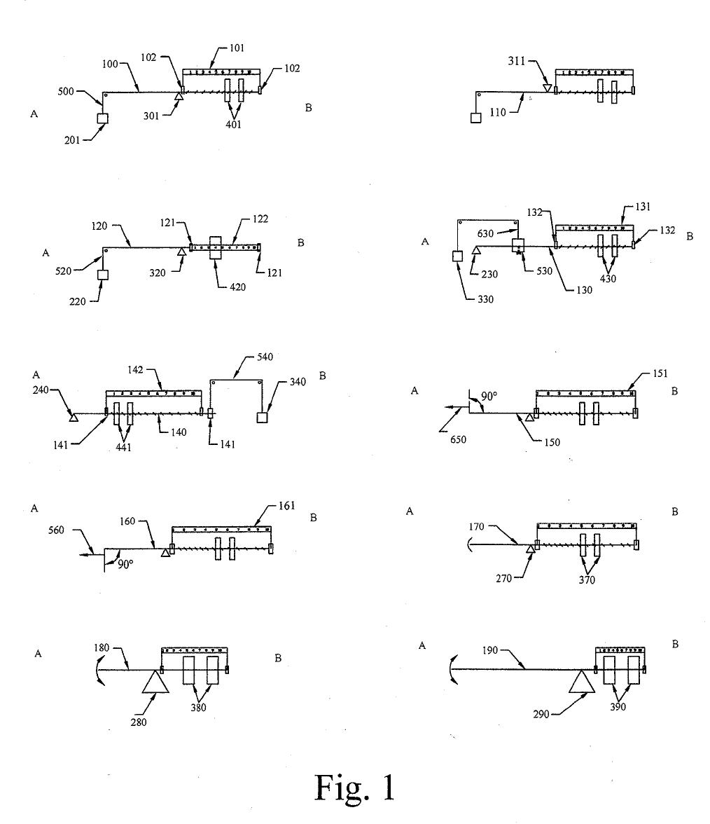

FIG. 1. General view of alternatives of the Device of the SARDA system.

An alternative of the Device installed on a support with two weights. The Device 100 is installed on a support 301. The Applied force on shoulder (A) and correspondingly the Object 201 is transferred by means of a connecting rod 500 and created by means of a Load (two weights) 401 moving along treads cut on shoulder (B) between stops 102. The graduated scale of the Applied force 101 makes it possible to define the size of the force applied onto Object 201.

An alternative of a suspension bracket of the Device is distinguished only by the fact that the Device 110 is suspended by means of a support 311.

An alternative of the Device with one weight. The Device 120 is installed on a support 320. The Applied force on shoulder (A) and correspondingly the Object 220 is transferred by means of a connecting rod 520 and created by means of a Load (one weight of special design) 420 moving along shoulder (B) between stops 121. The graduated scale of the Applied force 122 makes it possible to define the size of the force applied onto Object 220.

An alternative of the Device resting on a support at one end of the Device. The Device 130 is installed on a support 230 by one shoulder (for example “A”). The Applied force on shoulder (A) and correspondingly onto the Object 330 is transferred by means of a connecting rod 630 which fastens to shoulder (A) of the Device 130 by means of the slider 530. The slider 530 can be moved to any location of shoulder (A) of the Device 130. Movement of the slider 530 makes it possible to change (increase or decrease) the amplitude of fluctuation of the Object 330. The Applied force on shoulder (A) is created by means of a Load (one or two weights) 430 moving along shoulder (B) between stops 132. The graduated scale of the Applied force 131 makes it possible to define the size of the force applied onto the Object 330.

An alternative of the Device resting on a support at one end of the Device and a connecting rod 540 fastened to the other end of the Device 140. The Device 140 is installed on a support 240 by one shoulder (for example “A”). The Applied force on shoulder (A) and correspondingly onto the Object 340 is transferred by means of connecting rod 540 which fastens to an end point of shoulder (B) of the Device 140. The Applied force on Object 340 is created by means of a Load (one or two weights) 441 moving along shoulders (A) and (B) between stops 141. The graduated scale of the Applied force 142 makes it possible to define the size of the force applied onto the Object 340.

An alternative of the Device creating an elevating force. Both shoulders of the Device 100 (A) and (B) are in one plane in which the elevating force is created. That is, the Applied force on shoulder (B) creates an elevating force on shoulder (A). The graduated scale of the Applied force 101 makes it possible to define the size of the force applied onto the Object 201.

An alternative of the Device creating a pulling force. The shoulder (A) of the Device 150 turns 90 degrees upwards from horizontal and in this case creates a pulling force. That is, the Applied force on shoulder (B) creates a pulling force on shoulder (A). The graduated scale of the Applied force 151 makes it possible to define the size of the force applied onto the Object 650.

An alternative of the Device creating a pushing force. The shoulder (A) of the Device 160 turns 90 degrees downwards from horizontal and in this case creates a pushing force. That is, the Applied force on shoulder (B) creates a pushing force on shoulder (A). The graduated scale of the Applied force 161 makes it possible to define the size of the force applied onto the Object 560.

An alternative of the Device when it is necessary to create a small force on the Object with small amplitude of movement of the Object. The Device 170 has short shoulders (A) and (B), is fastened on a low support 270, and has a small Load by weight (one or two weights of small mass) 370.

An alternative of the Device when it is necessary to create a large force on the Object with large amplitude of movement of the Object. The Device 180 has long shoulders (A) and (B), is fastened on a high support 280, and has a large Load by weight (one or two weights of larger mass) 380.

An alternative of the Device when it necessary to create a force on the Object with large amplitude of movement of Object with one short shoulder. In this case, following the basic principle of the Balance Arm there is a gain in amplitude of fluctuation of the Object, but force exerted on the Object is lost. The Device 190 has a long shoulder (A) and a short shoulder (B), fastens on a high support 290, and has a larger Load by weight (one or two weights of larger mass) 390.

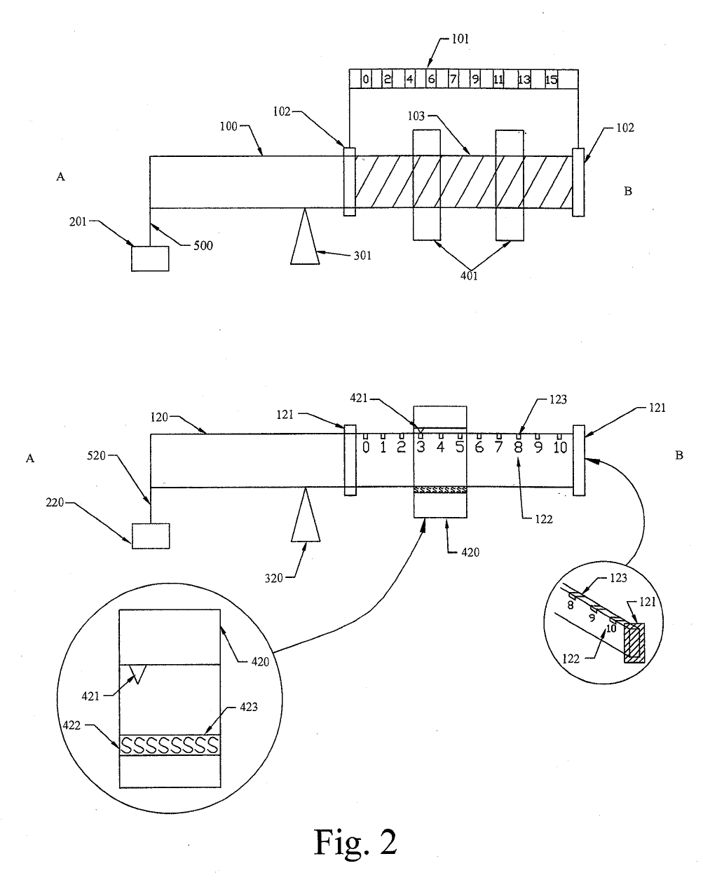

FIG. 2. Device with one and two weights and a scale of measurement of the size of the Applied force on the Object.

An alternative of the Device installed on a support with two weights. The Device 100 is installed on a support 301. The shoulder (A) of the Device is connected to the Object 201 by means of a connecting rod 500. On the second shoulder (B) are cut in treads 103 and along which moves a Load in the form of two weights 401 of special design. Weights may move between stops 102 to ensure reliable locking the positions of weights on the shoulder (B) to tighten them against each other sufficiently enough to exclude their spontaneous movement. The shoulder (B) of the Device 100 also has a graduated scale of the Applied force 101 that allows defining the size of the force applied onto the Object 201.

An alternative of the Device installed on a support with one weight. The Device 120 is installed on a support 320. The shoulder (A) of the Device is connected to the Object 220 by means of a connecting rod 520. On the second shoulder (B) are cut notches 123 in the form of small cuts. On shoulder (B) a Load moves, in the form of one weight 420 of special design. The weight can move between stops 121. The weight 420 has a “tooth” 421 equal in size to the notches 123. In the lower part of the weight is a plate 423 which presses the weight 420 from below toward the body of the Device 120 by means of springs 422. The Device 120 has rectangular section and notches 123 cut in it from above, and they are equal in size to the “tooth” 421 of the weight 420. The weight 420 is fixed under its own mass to shoulder (B) of the Device by means of “tooth” 421. A plate 423 and clamping springs 422 provide additional reliable locking in position of the weight on shoulder (B) and prevent spontaneous movement. The shoulder (B) of the Device 120 also has a graduated scale of the Applied force 122 that allows defining the size of the force applied onto the Object 220.

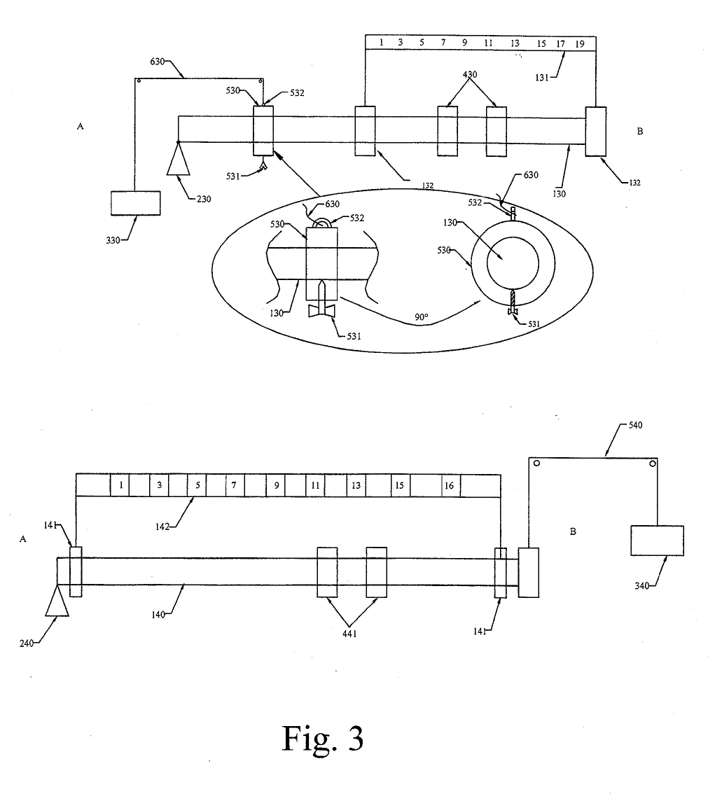

FIG. 3. Device resting one end of the Device on a support.

The alternative of the Device resting on a support at one end of the Device. The Device 130 is installed on a support 230 by one shoulder (for example “A”). The Applied force on shoulder (A) and correspondingly onto the Object 330 is transferred by means of a connecting rod 630 which fastens to shoulder (A) of the Device 130 by means of a slider 530. The slider 530 can be moved to any location of shoulder (A) of the Device 130. Movement of the slider 530 allows changing (increasing or decreasing) the amplitude of the fluctuation of the Load 330. The slider 530 is a metal ring with an opening in the middle through which the Device 130 enters. From above, the slider 530 has a small ring 532 for seating the connecting rod 630. From below, the slider 530 has a bolt 531 which is screwed in it and allows locking the position of the slider at any location on the Device of shoulder (A). The Applied force on shoulder (A) is created by means of a Load (one or two weights) 430 moving along shoulder (B) within stops 132. The graduated scale of the Applied force 131 allows defining the size of the force applied onto the Object 330.

The alternative of the Device resting on a support at one end of the Device 140 where a connecting rod 540 fastens to the other end of the Device 140. The Device 140 is installed on a support 240 by one end (for example shoulder “A”). The Applied force on shoulder (A) and correspondingly onto the Object 340 is transferred by means of a connecting rod 540 which fastens to the end point of shoulder (B) of the Device 140. The Applied force on the Object 340 is created by means of a Load (one or two weights) 441 moving along shoulders (A) and (B) within stops 141. The graduated scale of the Applied force 142 makes it possible to define the size of the force applied onto the Object 340.

While the principles of the invention have been made clear in illustrative embodiments, without departing from those principles there may occur to those skilled in the art modifications of structure, arrangement proportions, the elements, materials, and components used in the practice of the invention, and otherwise, which are particularly adapted to specific environments and operative requirements. The appended claims are intended to cover and embrace any all such modifications within the limits only of the true spirit and scope of the invention.

What we claim is:

1. A Balance Arm for creation of a variable applied force by means of a constant load as a device and a method (hereafter “Device” in the text) includes a Device, on one half of which (B) a constant load moves (for example 1 or 2 balance weights, but this is not obligatory) (hereafter “Load” in the text), which creates a variable applied force (hereafter “Applied force” in the text), onto the other half of the Device (A), to which is attached an object on which it is necessary to exert an applied force (hereafter “Object” in the text). Several alternatives of the Device are possible.
One of the alternatives is when on shoulder (B), along the treads cut on it, move two weights which can be fixed on any segment by simple tightening of the weights against each other.
The next alternative is when the Device can be both rested on a support located on the base, and suspended under the base, depending on the conditions of its use.
The next alternative is when just one weight of a special design and a notch on a shoulder (B) of the Device is sufficient, instead of a tread.
In each case, depending on requirements, it is possible to change the height of fluctuation of shoulder (A). This is achieved by changing the length of the shoulders, by moving the support to one side or another, or by lengthening one or both halves of the Device. This provides a larger or smaller length of one or both of the shoulders of the Device and correspondingly changes the amplitude of fluctuation of shoulder (A). In addition to this, it is possible also to change the height of the support, since this will affect the amplitude of fluctuation of shoulder (A). The method includes the possibility of selecting Devices with various maximum limits of the specified applied force reached, initially, by selection of a weight of constant load value and/or change of length of shoulder (A) and/or (B). Thus, if it is necessary to show a small applied force, this will be a Device with short shoulders (A) and (B) and small weights, and vice versa.
The next alternative is when the Device rests on a support at one end, for example from shoulder (A), and on the same half a slider moves, to which a connecting rod leading to the Object fastens. The slider allows moving the fastening of a connecting rod along shoulder (A) and correspondingly changing the amplitude of motion of the Object.
The next alternative is when the Device rests on a support at one end, for example from shoulder (A), and a connecting rod leading to the Object is fastened to the opposite end of the Device, for example to shoulder (B). And the Load moves along the entire length of the Device, from shoulder (A) to (B).
The next alternative is when shoulder (A) of the Device is turned 90 degrees upwards from the horizontal position, and this allows the Device to create a pulling force; and contrarily, when turned 90 degrees downwards from the horizontal position, to create a pushing force. In the horizontal position of the Device, an elevating force is created.

2. The Device designated in point 1, includes a Device as one alternative, on one half (B) of which one weight of a special design moves, having a tooth and a clamping spring in it, which allows creating an Applied force on the second half of the Device, shoulder (A);

3. The Device designated in point 2, includes one weight of a special design, which can be reliably fastened on any segment of shoulder (B) by means of notches cut on it and allows creation of an Applied force on shoulder (A) of the Device;

4. The Device designated in point 2, includes imposition of a graduated scale of the applied force on shoulder (B) and allows determining the applied force on the Object;

5. The Device designated in point 1, includes a Device and a method of using the Device, on one half (B) of which treads are cut and on which are moved two weights which permit creating an Applied force on the second half of the Device (A), to which the Object is attached;

6. The Device designated in point 5, includes the establishment of a graduated scale of the applied force of shoulder (B) that allows determining the applied force on the Object;

7. The Device designated in point 1, includes versions of fastening the Device to the base both from above and with the possibility of its suspension under the base, depending on need;

8. The Device designated in point 1, includes a Device, the length of the shoulders of which may be changed by means of moving the support to one side or another, depending on need;

9. The Device designated in point 1, includes a Device, the maximum vertical amplitude of fluctuation of which can be changed by means of changing the length of the shoulders of the Device, depending on need;

10. The Device designated in point 1, includes a Device, the maximum vertical amplitude of fluctuation of which can be changed by means of changing the height of the support for the Device, depending on need;

11. The Device designated in point 1, includes the capability of selecting Devices with various limits of the specified Applied force reached, initially, by selection of the weight of a Load and/or change in the length of shoulders (A) and/or (B). Thus if necessary to show a small applied force, this will be a Device with short shoulders (A) and/or (B) and small weights, and vice versa;

12. The Device designated in point 1, includes the Device and a method of using the Device by resting one end on a support;

13. The Device designated in point 12, includes the Device and a method of using it where to one of the shoulders (A), the connecting rod of which is attached by means of a slider, which can move along shoulder (A) and along the second shoulder (B) whose Load moves;

14. The Device designated in point 12, includes the Device and a method of using it where one of shoulders of the Device (A) is linked by a connecting rod leading to the Object, by means of a slider which allows changing the amplitude of fluctuation of the Object;

15. The Device designated in point 12, includes a method of using the Device resting one end on a support and where to the second end of the Device is attached a connecting rod leading to the Object and on the central part of which, a Load moves along shoulders (A) and (B);

16. The Device designated in point 12, includes establishment of a graduated scale of the applied force on shoulder (B) which allows defining the size of the force applied to the Object;

17. The Device designated in point 1, includes the Device and a method, shoulder (A) of which when in horizontal position creates a lifting force, when turned upwards 90 degrees from horizontal creates a pulling force, and when turned downwards 90 degrees from horizontal creates a pushing force;

18. The Device designated in point 1, includes a Device and method of using the Device for creation of an Applied force on one of its shoulders (A) to which the Object is connected, by using a Load which moves along the second of the shoulders (B) of the Device, and this can be used in any types of machines, mechanisms, instruments, sports apparatus and other devices and mechanisms without restriction;
